(19) United States
(12) Patent Application Publication
(10) Pub. No.: US 2005/0252352 A1
(43) Pub. Date: Nov. 17, 2005

(54) Liquid jet machining apparatus

(75) Inventor: Satoshi Tateiwa, Tokyo (JP)

Correspondence Address: SMITH, GAMBRELL & RUSSELL, LLP, 1850 M STREET, N.W., SUITE 800, WASHINGTON, DC, 20036, US

(73) Assignee: Disco Corporation

(21) Appl. No.: 11/116,185

(22) Filed: Apr. 28, 2005

(30) Foreign Application Priority Data
May 13, 2004 (JP) 2004-143842

(51) Int. Cl. B26F 3/00

(52) U.S. Cl. 83/177

(57) ABSTRACT

A liquid jet machining apparatus comprising holding means for holding a workpiece, and liquid jet application means for applying a liquid jet to the workpiece held by the holding means. The liquid jet application means includes pipe means and nozzle means, and the nozzle means includes a nozzle pipe connected to the downstream end of the pipe means, and an orifice member connected to the downstream end of the nozzle pipe. The nozzles means is firmly fixed to a rigid support frame body. A downstream end portion of the pipe means is also firmly fixed to the rigid support frame body.

### FIELD OF THE INVENTION

This invention relates to a liquid jet machining apparatus comprising a holding means for holding a workpiece, and a liquid jet application means for applying a liquid jet to the workpiece held by the holding means.

### DESCRIPTION OF THE PRIOR ART

As disclosed in Japanese Patent Publication No. 1989-3626, Japanese Patent Application Laid-Open No. 1990-232199, Japanese Patent Application Laid-Open No. 1992-256600, Japanese Patent Application Laid-Open No. 1998-249800, and Officially Published Patent Gazette No. 2003-507202, a liquid jet machining apparatus which applies a liquid jet to a workpiece is used for workpiece precision machining such as cutting of a semiconductor substrate. Such a liquid jet machining apparatus comprises a holding means for holding a workpiece, and a liquid jet application means for applying a liquid jet, such as a water jet, to the workpiece held by the holding means. The liquid jet application means includes a pipe means and a nozzle means, and the nozzle means includes a nozzle pipe connected to the downstream end of the pipe means, and an orifice member connected to the downstream end of the nozzle pipe. A high pressure liquid is supplied to the nozzle means through the pipe means, and such a liquid is passed through an orifice, whereby the liquid is brought to a high velocity, for example, a high velocity two to three times the sound velocity, and is applied at this high velocity to the workpiece.

The inventors diligently studied the machining accuracy of the conventional liquid jet machining apparatus, and have recognized the following facts: With the conventional liquid jet machining apparatus, the nozzle means is finely vibrated, since the liquid jet is ejected from the nozzle means. As a result, the accuracy of liquid jet application to the workpiece is decreased. The fine vibrations of the nozzle means are presumed to be due to pulsations of the liquid jet ejected through the nozzle means. The vibrations of the nozzle means are so fine that the decrease in the liquid jet application accuracy is also relatively small. However, machining such as cutting of a semiconductor substrate is required to be markedly precise to such a degree as not to permit a decrease in liquid jet application accuracy due to vibrations of the nozzle means.

### SUMMARY OF THE INVENTION

It is a principal object of the present invention, therefore, to provide an improved liquid jet machining apparatus with sufficiently high accuracy of liquid jet application to a workpiece.

Based on the above-mentioned recognition concerned with the machining accuracy of the conventional liquid jet machining apparatus, the inventors have found that the above principal object can be attained by firmly fixing the nozzle means to a rigid support frame body. The term “firmly fixing” (including “firmly fixed”), as used herein, refers to such fixing as to make movement substantially impossible. This term excludes the mode of movable mounting, or the mode of mounting via an elastic or low rigidity member.

According to the present invention, there is provided, as a liquid jet machining apparatus for attaining the above principal technical object, a liquid jet machining apparatus comprising holding means for holding a workpiece, and liquid jet application means for applying a liquid jet to the workpiece held by the holding means, the liquid jet application means including pipe means and nozzle means, the nozzle means including a nozzle pipe connected to the downstream end of the pipe means, and an orifice member connected to the downstream end of the nozzle pipe, and wherein the nozzle means is firmly fixed to a rigid support frame body.

Preferably, the nozzle pipe of the nozzle means is firmly fixed to the rigid support frame body, whereby the nozzle means is firmly fixed to the rigid support frame body. In a preferred embodiment, the liquid jet machining apparatus further comprises a receiving member firmly fixed to the rigid support frame body and having a receiving groove for partly receiving the nozzle pipe, and a restraining member detachably mounted on the receiving member and having a restraining groove for partly receiving the nozzle pipe, and wherein with the restraining groove being opposed to the receiving groove, and the nozzle pipe being accommodated in the receiving groove and the restraining groove, the restraining member is mounted on the receiving member, and the nozzle pipe is held between the receiving member and the restraining member, whereby the nozzle pipe is firmly fixed to the rigid support frame body. Preferably, the nozzle pipe is cylindrical, and the receiving groove and the restraining groove cooperatively define a nozzle pipe accommodation space whose cross-sectional shape is circular. Preferably, a downstream end portion of the pipe means is also firmly fixed to the rigid support frame body. In a preferred embodiment, the liquid jet machining apparatus further comprises a receiving member firmly fixed to the rigid support frame body, and having a first receiving groove for partly receiving the nozzle pipe, and a second receiving groove for partly receiving the downstream end portion of the pipe means, a first restraining member detachably mounted on the receiving member and having a first restraining groove partly receiving the nozzle pipe, and a second restraining member detachably mounted on the receiving member and having a second restraining groove partly receiving the downstream end portion of the pipe means, and wherein with the first restraining groove being opposed to the first receiving groove, and the nozzle pipe being accommodated in the first receiving groove and the first restraining groove, the first restraining member is mounted on the receiving member, and the nozzle pipe is held between the receiving member and the first restraining member, and with the second restraining groove being opposed to the second receiving groove, and the downstream end portion of the pipe means being accommodated in the second receiving groove and the second restraining groove, the second restraining member is mounted on the receiving member, and the downstream end portion of the pipe means is held between the receiving member and the second restraining member, whereby the nozzle pipe and the downstream end portion of the pipe means are firmly fixed to the rigid support frame body. Preferably, the nozzle pipe is cylindrical, and the first receiving groove and the first restraining groove cooperatively define a nozzle pipe accommodation space whose cross-sectional shape is circular, and the downstream end portion of the pipe means is cylindrical, and the second receiving groove and the second restraining groove cooperatively define a pipe means downstream end portion accommodation space whose cross-sectional shape is circular.

### BRIEF DESCRIPTION OF THE DRAWINGS

FIG. 1 is a schematic view showing, in a simplified manner, the entire configuration of a liquid jet machining apparatus to which the present invention is applied.

FIG. 2 is a sectional view showing a nozzle means in the liquid jet machining apparatus shown in FIG. 1.

FIG. 3 is a side view showing the manner of fixing a downstream end portion of pipe means and the nozzle means in the liquid jet machining apparatus shown in FIG. 1.

FIG. 4 is a front view showing the manner of fixing the downstream end portion of the pipe means and the nozzle means in the liquid jet machining apparatus shown in FIG. 1.

FIG. 5 is a sectional view taken along the line V-V in FIG. 4.

FIG. 6 is a sectional view taken along the line VI-VI in FIG. 4.

### DETAILED DESCRIPTION OF THE PREFERRED EMBODIMENTS

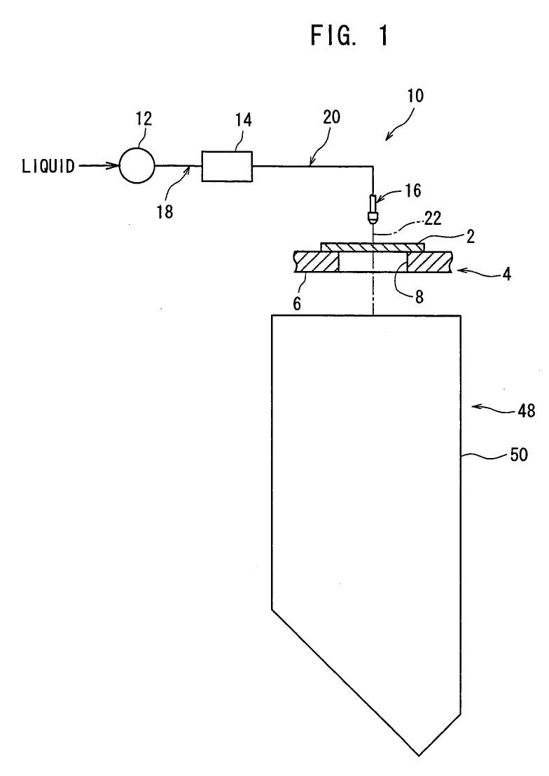

FIG. 1 schematically shows a preferred embodiment of a liquid jet machining apparatus constructed in accordance with the present invention. The liquid jet machining apparatus has a holding means 4 for holding a workpiece 2, such as a semiconductor substrate. The illustrated holding means 4 is composed of a holding plate 6 extending substantially horizontally, and an opening 8, as a through-hole, which may be rectangular or circular is formed in the holding plate 6. The holding plate 6 is mounted to be movable in a right-and-left direction, in a direction perpendicular to the sheet face, and in an up-and-down direction in FIG. 1, and is moved by a suitable drive means (not shown) in the right-and-left direction, in the direction perpendicular to the sheet face, and in the up-and-down direction in FIG. 1. The workpiece 2 is fixed onto the holding plate 6 by a suitable fixing means (not shown), such as a cramp means or a vacuum attraction means, such that a site of the workpiece 2 to be machined, namely, its site to be cut, is located on the opening 8.

The liquid jet machining apparatus also includes a liquid jet application means indicated entirely at the numeral 10. The illustrated liquid jet application means 10 includes a liquid pressurization means 12, an abrasive incorporation means 14, and a nozzle means 16. A pipe means 18 is disposed between the liquid pressurization means 12 and the abrasive incorporation means 14, and a pipe means 20 is disposed between the abrasive incorporation means 14 and the nozzle means 16. The liquid pressurization means 12, which can be composed of a high pressure pump, is supplied with a liquid which may be tap water or pure water. The liquid pressurization means 12 pressurizes the supplied liquid to make it into a high pressure liquid at a pressure of, say, 600 to 700 bars, and supplies such a high pressure liquid to the abrasive incorporation means 14. In the abrasive incorporation means 14, an abrasive is incorporated into the high pressure liquid. The abrasive may be garnet grains, diamond grains, or alumina grains having a grain size of the order of several tens of micrometers. The nozzle means 16 is disposed above the holding means 4. The high pressure liquid, which has the abrasive incorporated therein, is supplied to the nozzle means 16, which releases a liquid jet 22 (such a liquid jet is indicated by a long dashed dotted line in FIG. 1) vertically downwardly toward the workpiece 2 held by the holding means 4. The velocity of the liquid jet 22 is advantageously on the order of 2 to 3 times the sound velocity.

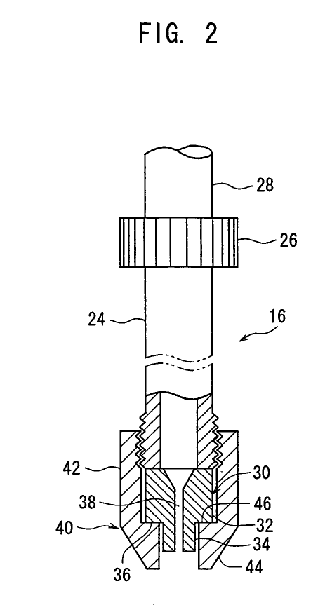

As clearly shown in FIG. 2, the nozzle means 16 includes a nozzle pipe 24 which is preferably formed from a high rigidity metal such as stainless steel. The upstream end of the nozzle pipe 24, which may be in the shape of a slender cylinder, is connected to the downstream end of a pipe member 28, which defines a downstream end portion of the pipe means 20, via a joint means 26. The nozzle means 16 further includes an orifice member 30 connected to the downstream end of the nozzle pipe 24. Preferably, the orifice member 30 is also formed from a high rigidity metal such as stainless steel. In the illustrated embodiment, the orifice member 30 has an upper portion 32 having a relatively large outer diameter, and a lower portion 34 having a relatively small outer diameter. An annular shoulder surface 36 pointing downward is formed in a boundary region between the outer peripheral surface of the upper portion 32 and the outer peripheral surface of the lower portion 34. An orifice 38 is formed at the center of the orifice member 30. The orifice member 30 of this configuration is disposed below the nozzle pipe 24, and is fixed in place by mounting a cover member 40 on a lower end portion of the nozzle pipe 24. The cover member 40 has an upper portion 42 having a relatively large internal diameter, and a lower portion 44 having a relatively small internal diameter. An annular shoulder surface 46 pointing upward is formed between the inner peripheral surface of the upper portion 42 and the inner peripheral surface of the lower portion 44. An internal thread is formed in an upper part of the inner peripheral surface of the upper portion 42. By bringing this internal thread into engagement with an external thread formed in a lower part of the outer peripheral surface of the nozzle pipe 24, the cover member 40 is mounted on the lower end portion of the nozzle pipe 24. Also, the shoulder surface 46 of the cover member 40 is brought into contact with the shoulder surface 36 of the orifice member 30, and the upper end surface of the orifice member 30 is brought into contact with the lower end surface of the nozzle pipe 24.

A catching means 48 is disposed below the holding means 4. The catching means 48 includes a tank 50 open at the upper surface, and a liquid which may be tap water or pure water is accommodated in the tank 50. The liquid jet 22 released from the nozzle means 16 penetrates the workpiece 2, passes through the opening 8 of the holding plate 6, and advances into the tank 50 of the catching means 48. When the holding means 4 is moved, as appropriate, with the nozzle means 16 kept releasing the liquid jet 22, the workpiece 2 is cut along the path of movement of the holding means 4. The abrasive, which has been incorporated into the liquid jet 22 and thrown into the tank 50, can be recovered by a suitable recovery means (not shown), and supplied again into the abrasive incorporation means 14.

The above-described features of the holding means 4, the liquid jet application means 10, and the catching means 48 in the illustrated liquid jet machining apparatus do not constitute the novel characteristics of the liquid jet machining apparatus constructed in accordance with the present invention. Since these members may themselves be of well known forms, their detailed descriptions are omitted herein.

In the liquid jet machining apparatus constructed in accordance with the present invention, it is important that the nozzle means 16, preferably, the downstream end portion of the pipe means 18, in addition to the nozzle means 16, is firmly fixed to a rigid support frame body.

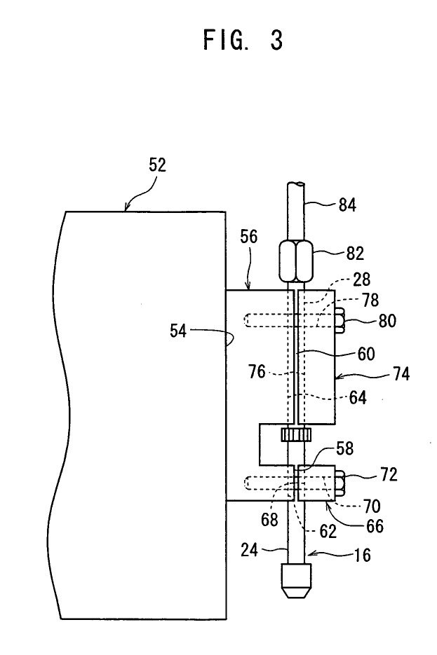

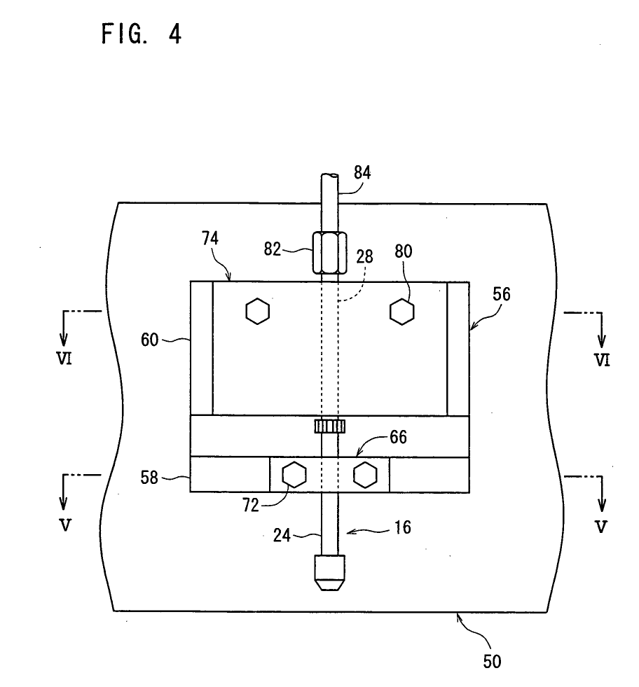

Further with reference to FIGS. 3 to 6, the liquid jet machining apparatus is furnished with a stationary rigid support frame body 52 (partly shown in FIGS. 3 and 4) formed from a high rigidity metal such as steel. The rigid support frame body 52 has a front surface 54 extending substantially vertically. A receiving member 56 is firmly fixed to the front surface 54 of the rigid support frame body 52 by a suitable mode of fixing, such as welding. The receiving member 56, formed from a high rigidity metal such as steel, includes a first receiving portion 58 and a second receiving portion 60. A first receiving groove 62, extending continuously from the upper end to the lower end of the first receiving portion 58, is formed in the front surface of the first receiving portion 58. The cross-sectional shape of the first receiving groove 62 is semicircular. A second receiving groove 64, extending continuously from the upper end to the lower end of the second receiving portion 60, is formed in the front surface of the second receiving portion 60. The cross-sectional shape of the second receiving groove 64 is also semicircular.

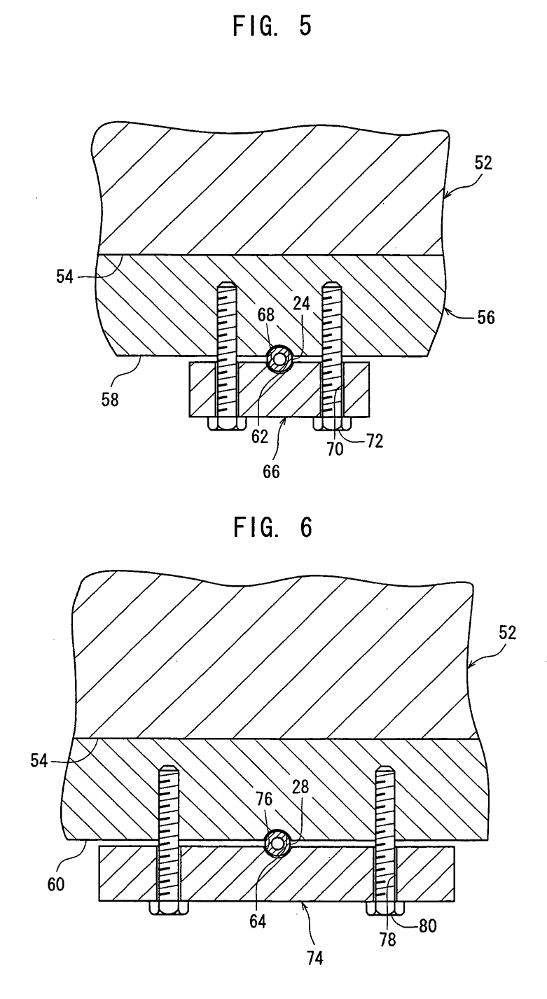

As clearly understood by reference to FIGS. 3, 4 and 5, a nearly intermediate portion in the axial direction of the nozzle pipe 24 of the nozzle means 16 is partly received by the first receiving groove 62 formed in the first receiving portion 58 of the receiving member 56. A first restraining member 66 is detachably mounted on the front surface of the first receiving portion 58. A first restraining groove 68, extending continuously from the upper end to the lower end of the first restraining member 66, is formed in the first restraining member 66 formed from a high rigidity metal such as steel. With the first restraining groove 68 being opposed to the first receiving groove 62, the first restraining member 66 is mounted on the front surface of the first receiving portion 58. The cross-sectional shape of the first restraining groove 68 is semicircular and, as clearly understood from FIG. 5, the nearly intermediate portion in the axial direction of the nozzle pipe 24 of the nozzle means 16 is held between the first receiving portion 58 of the receiving member 56 and the first restraining member 66 in such a state as to be accommodated in the first receiving groove 62 and the first restraining groove 68 opposed thereto. Thus, the nozzle pipe 24, accordingly, the nozzle means 16, is firmly fixed to the rigid support frame body 52. The cross-sectional shape of the space defined by the cooperation between the first receiving groove 62 and the first restraining groove 68 is circular, and the inner diameter of this space is advantageously slightly smaller than the outer diameter of the nozzle pipe 24 to be held between those members. Mounting of the first restraining member 66 onto the first receiving portion 58 is advantageously achieved by screwing fastening bolts 72 into internal threads, which are disposed in the first receiving portion 58, via two through-holes 70 disposed on both sides of the first restraining groove 68.

As clearly understood by reference to FIGS. 3, 4 and 6, the aforementioned pipe member 28, which defines the downstream end portion of the pipe means 18, is partly received by the second receiving groove 64 formed in the second receiving portion 60 of the receiving member 56. A second restraining member 74 is detachably mounted on the front surface of the second receiving portion 60. A second restraining groove 76, extending continuously from the upper end to the lower end of the second restraining member 74, is formed in the second restraining member 74 formed from a high rigidity metal such as steel. With the second restraining groove 76 being opposed to the second receiving groove 64, the second restraining member 74 is mounted on the front surface of the second receiving portion 60. The cross-sectional shape of the second restraining groove 76 is semicircular and, as clearly understood from FIG. 6, nearly the whole in the axial direction of the pipe member 28 is held between the second receiving portion 60 of the receiving member 56 and the second restraining member 74 in such a state as to be accommodated in the second receiving groove 64 and the second restraining groove 76 opposed thereto. Thus, the pipe member 28, namely, the downstream end portion of the pipe means 18, is firmly fixed to the rigid support frame body 52. The cross-sectional shape of the space defined by the cooperation between the second receiving groove 64 and the second restraining groove 76 is circular, and the inner diameter of this space is advantageously slightly smaller than the outer diameter of the pipe member 28 to be held between those members. Mounting of the second restraining member 74 onto the second receiving portion 60 is advantageously achieved by screwing fastening bolts 80 into internal threads, which are disposed in the second receiving portion 60, via two through-holes 78 disposed on both sides of the second restraining groove 76. The upstream end of the pipe member 28 is connected to the downstream end of a pipe member 84, which is located upstream of the pipe member 28, via a suitable joint means 82.

In the liquid jet machining apparatus as described above, the nozzle pipe 24 of the nozzle means 16, preferably, the pipe member 28 defining the downstream end portion of the pipe means 18, as well as the nozzle pipe 24 of the nozzle means 16, is firmly fixed to the rigid support frame body 52. Thus, fine vibrations of the nozzle means 16 are sufficiently prevented or suppressed. Consequently, the liquid jet 22 can be applied to a predetermined site of the workpiece 2 with sufficiently high accuracy.

While the preferred embodiments of the liquid jet machining apparatus constructed according to the present invention have been described in detail by reference to the accompanying drawings, it is to be understood that the invention is not limited to such embodiments, but various changes and modifications may be made without departing from the scope of the present invention.

1. A liquid jet machining apparatus comprising
holding means for holding a workpiece, and
liquid jet application means for applying a liquid jet to the workpiece held by the holding means,
the liquid jet application means including pipe means and nozzle means,
the nozzle means including a nozzle pipe connected to a downstream end of the pipe means, and an orifice member connected to a downstream end of the nozzle pipe, and
wherein the nozzle means is firmly fixed to a rigid support frame body.

2. The liquid jet machining apparatus according to claim 1, wherein
the nozzle pipe of the nozzle means is firmly fixed to the rigid support frame body,
whereby the nozzle means is firmly fixed to the rigid support frame body.

3. The liquid jet machining apparatus according to claim 2, further comprising
a receiving member firmly fixed to the rigid support frame body and having a receiving groove for partly receiving the nozzle pipe, and
a restraining member detachably mounted on the receiving member and having a restraining groove for partly receiving the nozzle pipe, and wherein
with the restraining groove being opposed to the receiving groove, and the nozzle pipe being accommodated in the receiving groove and the restraining groove, the restraining member is mounted on the receiving member, and the nozzle pipe is held between the receiving member and the restraining member,
whereby the nozzle pipe is firmly fixed to the rigid support frame body.

4. The liquid jet machining apparatus according to claim 3, wherein
the nozzle pipe is cylindrical, and
the receiving groove and the restraining groove cooperatively define a nozzle pipe accommodation space whose cross-sectional shape is circular.

5. The liquid jet machining apparatus according to claim 1, wherein
a downstream end portion of the pipe means is also firmly fixed to the rigid support frame body.

6. The liquid jet machining apparatus according to claim 5, wherein
the nozzle pipe of the nozzle means is firmly fixed to the rigid support frame body,
whereby the nozzle means is firmly fixed to the rigid support frame body.

7. The liquid jet machining apparatus according to claim 6, further comprising
a receiving member firmly fixed to the rigid support frame body, and having a first receiving groove for partly receiving the nozzle pipe, and a second receiving groove for partly receiving the downstream end portion of the pipe means,
a first restraining member detachably mounted on the receiving member and having a first restraining groove partly receiving the nozzle pipe, and
a second restraining member detachably mounted on the receiving member and having a second restraining groove partly receiving the downstream end portion of the pipe means, and wherein
with the first restraining groove being opposed to the first receiving groove, and the nozzle pipe being accommodated in the first receiving groove and the first restraining groove, the first restraining member is mounted on the receiving member, and the nozzle pipe is held between the receiving member and the first restraining member, and
with the second restraining groove being opposed to the second receiving groove, and the downstream end portion of the pipe means being accommodated in the second receiving groove and the second restraining groove, the second restraining member is mounted on the receiving member, and the downstream end portion of the pipe means is held between the receiving member and the second restraining member,
whereby the nozzle pipe and the downstream end portion of the pipe means are firmly fixed to the rigid support frame body.

8. The liquid jet machining apparatus according to claim 7, wherein
the nozzle pipe is cylindrical, and the first receiving groove and the first restraining groove cooperatively define a nozzle pipe accommodation space whose cross-sectional shape is circular, and
the downstream end portion of the pipe means is cylindrical, and the second receiving groove and the second restraining groove cooperatively define a pipe means downstream end portion accommodation space whose cross-sectional shape is circular.
